(19) United States
(12) Patent Application Publication
(10) Pub. No.: US 2021/0345474 A1
(43) Pub. Date: Nov. 4, 2021

(54) A CONDUCTIVE APPARATUS

(71) Applicant: Earthling 3.0 Pty Ltd, Pasadena (AU)

(72) Inventor: George IOANNOU, Pasadena (AU)

(73) Assignee: Earthling 3.0 Pty Ltd, Pasadena (AU)

(21) Appl. No.: 17/284,517

(22) PCT Filed: Oct. 11, 2019
(86) PCT No.: PCT/AU2019/051106

§ 371 Date: Apr. 12, 2021

(30) Foreign Application Priority Data
Oct. 11, 2018 (AU) 2018903840
Apr. 15, 2019 (AU) 2019901293

(51) Int. Cl. H05F 3/02; A43B 7/36

(52) U.S. Cl. CPC H05F 3/02; A43B 7/36

(57) ABSTRACT

A conductive apparatus, including: a first conductive portion for attaching to an inner portion of a footwear garment; a second conductive portion for attaching to an underside of the footwear garment; and a connecting portion that at least partly extends along an outside of the footwear garment, the connecting portion electrically connecting the first conductive portion and the second conductive portion; wherein the conductive apparatus is a flexible strap including: an adhesive layer; a first conductive layer; and a second conductive layer provided on at least the second conductive portion. The strap includes a top layer, wherein the top layer is formed from a material that accepts printing, and wherein the top layer is perforated to allow contact with the conductive portion beneath the top layer.

### TECHNICAL FIELD

The present disclosure generally relates to conductive apparatuses, in particular wearable conductive apparatuses for footwear.

### BACKGROUND OF THE INVENTION

The term “earthing” or “grounding” refers to a human body being in contact with the surface of the earth by barefoot exposure outdoors or using special indoor systems connected to the earth. Such contact enables transfer of the earth's free electrons into and/or from the electrically conductive human body.

Studies indicate that grounding may provide beneficial effects to the body, e.g., improving blood flow, reducing inflammatory response, reducing muscle soreness, and/or decreasing post-exercise muscle damage.

Some devices have been proposed to facilitate grounding human bodies to the earth. For example, one device allows a user to be grounded by putting the user's feet on a conductive mat, the mat being connected into the ground port of an electric power outlet via conductive wires; however, when using this device, in order to maintain in contact with the mat, the user is required to stand or sit in a fixed location, which may be inconvenient or undesirable.

Whilst earthing straps have been found to be effective, they lack durability and the ability to be printed on for branding purposes. This is primarily because the conductive layer is on the top layer of the strap. To achieve a conductive plastic element suitable for making a strap carbon is added to the plastic. High levels of carbon are desirable to make the strap more conductive, however doing so makes the strap more brittle. High carbon plastics also have problems retaining ink printed onto them, making branding difficult.

It is desired to address or ameliorate one or more disadvantages or limitations associated with the prior art, or to at least provide a useful alternative.

### SUMMARY OF THE INVENTION

In accordance with the present invention, there is provided a conductive apparatus, including: a first conductive portion for attaching to an inner portion of a footwear garment; a second conductive portion for attaching to an underside of the footwear garment; and a connecting portion that at least partly extends along an outside of the footwear garment, the connecting portion electrically connecting the first conductive portion and the second conductive portion; wherein the conductive apparatus is a flexible strap including: an adhesive layer; a first conductive layer; and a second conductive layer provided on at least the second conductive portion.

In accordance with the present invention, there is provided a method of manufacturing a conductive apparatus, including: attaching a first conductive layer to a transfer layer to form a first sheet; attaching a flexible layer to an adhesive layer to form a second sheet; attaching the transfer layer of the first sheet to the flexible layer of the second sheet; attaching a second conductive layer to the first conductive layer to form a flexible conductive sheet; and forming a conductive apparatus using the flexible conductive sheet, wherein the conductive apparatus includes: a first conductive portion for attaching to an inner portion of a footwear garment; a second conductive portion for attaching to an underside of the footwear garment; and a connecting portion electrically connecting the first conductive portion and the second conductive portion; wherein the second conductive layer is provided on at least the second conductive portion.

In accordance with the present invention, there is provided a kit for applying a conductive apparatus to a footwear garment, including: a conductive apparatus, including: a first conductive portion for attaching to an inner portion of the footwear garment; a second conductive portion for attaching to an underside of the footwear garment; and a connecting portion that at least partly extends along an outside of the footwear garment, the connecting portion electrically connecting the first conductive portion and the second conductive portion; a priming substance for preparing an area on the underside of the footwear garment where the second conductive portion is to be attached; and at least one priming tool for applying the priming substance to the area on the underside of the footwear garment.

In accordance with the present invention, there is provided a method of using a conductive apparatus, including: applying a priming substance to an area on an underside of a footwear garment; attaching one conductive portion of a conductive apparatus to the primed area on the underside of the footwear garment; and attaching another conductive portion of the conductive apparatus to an inner portion of the footwear garment; wherein the two conductive portions of the conductive apparatus are electrically connected via a connecting portion of the conductive apparatus.

In a further form of the invention there is provided a personal earthing strap comprising at least one conductive layer and a top layer, wherein the top layer is formed from a material that accepts printing, and wherein the top layer is perforated to allow contact with a conductive layer beneath it.

Preferably the strap comprises a plurality of conductive layers held together with double sided conductive adhesive, wherein a first conductive layer comprises a relatively high proportion of carbon to provide a relatively low surface conductivity, and a second conductive layer comprises a relatively low proportion of carbon to provide a relatively high surface conductivity.

### BRIEF DESCRIPTION OF THE DRAWINGS

Some embodiments of the present invention are hereinafter further described, by way of example only, with reference to the accompanying drawings, in which:

FIG. 1 is a front view of a conductive apparatus;

FIG. 2 is a back view of the conductive apparatus;

FIG. 3 is a side view of the conductive apparatus;

FIG. 4 is a perspective view of the conductive apparatus in a fitted position;

FIG. 5 is a side view of a footwear garment showing the conductive apparatus in use according to a first example;

FIG. 6 is a cross-sectional back view of the footwear garment in FIG. 5 along line A′-A′ of FIG. 5;

FIG. 7 is back view of a footwear garment showing the conductive apparatus in use according to a second example;

FIG. 8 is a cross-sectional side view of the footwear garment in FIG. 7 along line B′-B′ of FIG. 7;

FIG. 9 is a schematic diagram showing an exemplary manufacturing process of the conductive apparatus;

FIG. 10 shows a top view of an earthing strap according to the present invention including a printed logo;

FIG. 11 illustrates shows a cross sectional view of the earthing strap of FIG. 10;

FIG. 12 shows a top view of a portion of the top layer of the earthing strap of FIG. 10.

FIG. 13 shows a side view of a shoe with the earthing strap of FIG. 10 fitted; and

FIG. 14 is a cross sectional view of the shoe with earthing strap fitted of FIG. 13

### DETAILED DESCRIPTION

Described herein is a conductive apparatus in the form of a conductive device 100.

As shown in FIGS. 1 to 4, the conductive device 100 includes a first conductive portion 102 formed at one end of the conductive device 100, a second conductive portion 104 at another end of the conductive device 100, and a connecting portion 106 between the first conductive portion 102 and the second conductive portion 104, thus the whole device 100 is conductive.

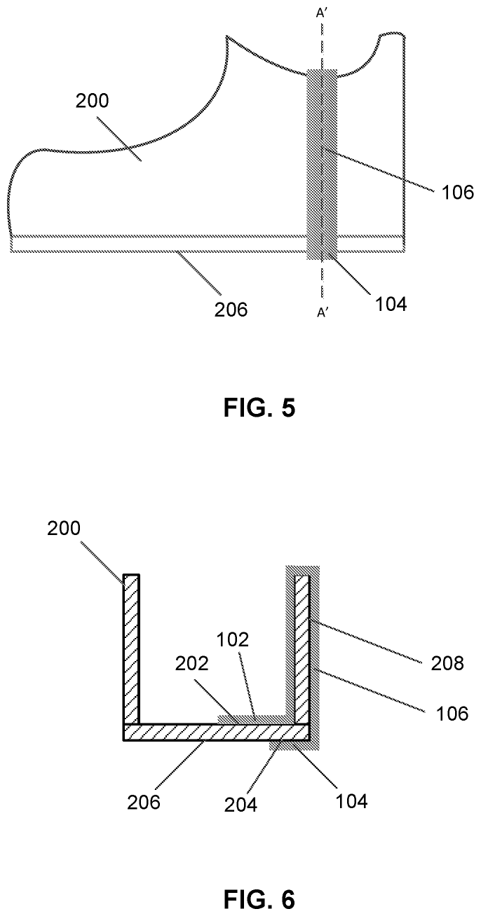

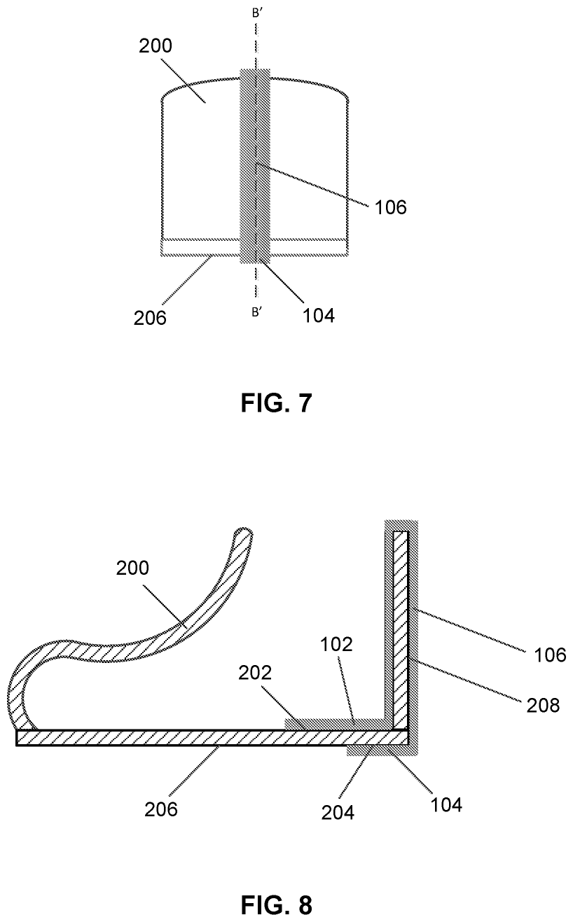

As shown in FIGS. 5 to 8, the conductive device 100 is attachable to a footwear garment 200. The conductive device 100 is manually attachable to the footwear garment 200, i.e., can be attached by hand. The conductive device 100 is removably attachable to the footwear garment 200. The footwear garment 200 may be any suitable type of footwear.

As shown in FIGS. 6 and 8, when attaching to the footwear garment 200, the first conductive portion 102 attaches to an inner portion 202 of the footwear garment 200, while the second conductive portion 104 attaches to an outer portion 204 on an underside 206 of the footwear garment 200.

The first conductive portion 102 and the second conductive portion 104 attach to the footwear garment 200 adhesively.

The first conductive portion 102 and the second conductive portion 104 are electrically connected by, with, and through the connecting portion 106, which at least partly extends along an outside 208 of the footwear garment 200.

As shown in FIGS. 1 to 3, the connecting portion 106 has an elongate shape, i.e., is elongated. The first conductive portion 102 and the second conductive portion 104 each have a greater width than the connecting portion 106. The first conductive portion 102 has a greater length than the second conductive portion 104, which may facilitate providing a reliable electrical connection between the first conductive portion 102 and the human body. In this disclosure, the term “length” refers to the dimension in the device 100's longitudinal direction, shown by arrow X in FIG. 1, and the term “width” refers to the dimension in the transverse direction, shown by the arrow Y in FIG. 1; the third orthogonal direction is “thickness”, described hereinafter.

As shown in FIG. 3, both the first conductive portion 102 and the second conductive portion 104 are substantially flat or “planar”, which may increase the user's comfort while wearing the conductive device 100, and may reduce or prevent any obstruction to the user's movement caused by the conductive device 100.

The conductive device 100 is in the form of a flexible strap that is adaptable to at least part of a contour the footwear garment 200.

As shown in FIG. 3, the flexible strap includes plurality of layers, i.e.:

a. an adhesive layer 112;

b. a first conductive layer 118; and

c. a second conductive layer 120.

The second conductive layer 120 is provided on at least the second conductive portion 104 attachable to the underside 206 of the footwear garment 200. In some embodiments, as shown in FIG. 3, the second conductive layer 120 is provided on both the first conductive portion 102 and the second conductive portion 104.

Optionally, the flexible strap may further include:

a. a flexible layer 114; and

b. a transfer layer 116.

As shown in FIG. 3, the flexible layer 114 and the transfer layer 116 are located between the adhesive layer 112 and the first conductive layer 118.

The adhesive layer 112 is formed of a double-sided acrylic adhesive tape, double-sided rubber based adhesive, spray adhesives, or silicone-based adhesive.

The flexible layer 114 is a polymer layer that is formed by a flexible polyvinyl chloride (PVC) film or a rubber layer. In some embodiments, the flexible layer 114 is a nitrile rubber.

The transfer layer 116 is a tape layer in the form of an acrylic transfer tape, a spray adhesive layer, a glue layer, or a heat press layer.

The first conductive layer 118 is a polymer film in the form of an antistatic polyethylene plastic film, antistatic PVC, antistatic rubber, or antistatic vinyl. In some embodiments, the first conductive layer 118 is a carbon loaded conductive polyethylene film.

The second conductive layer 120 is a polymer film in the form of an antistatic polyethylene plastic film, antistatic PVC, antistatic rubber, or antistatic vinyl. In some embodiments, the second conductive layer 120 is a carbon loaded conductive polyethylene film.

Preferably, the second conductive layer 120 has a higher conductivity than the first conductive layer 118. Alternatively, the second conductive layer 120 may have the same conductivity as the first conductive layer 118. However, having the second conductive layer 120 with a higher conductivity may improve the grounding functionality of the conductive apparatus 100.

The second conductive layer 120 is provided on at least the second conductive portion 104. As the second conductive portion 104 fits to the underside of the footwear garment 200, providing an extra conductive layer at least on the second conductive portion 104 there may further enhance the durability and increase the service life of the conductive apparatus 100. Preferably, the second conductive layer 120 is provided on both the first conductive portion 102 and the second conductive portion 104.

In some embodiments, as shown in FIG. 3, the second conductive layer 120 is attached to the first conductive layer 118 via a first conductive adhesive layer 122.

The first conductive adhesive layer 122 is a Xinst210 conductive adhesive tape.

In some embodiments, as shown in FIG. 3, the flexible strap may further include a third conductive layer 124. Preferably, the third conductive layer 124 is provided on at least the second conductive portion 104.

The third conductive layer 124 is a polymer film in the form of an antistatic polyethylene plastic film, antistatic PVC, antistatic rubber, or antistatic vinyl. In some embodiments, the third conductive layer 124 is a carbon loaded conductive polyethylene film.

Preferably, the third conductive layer 124 has a higher conductivity than the first conductive layer 118. Alternatively, the third conductive layer 124 may have the same conductivity as the first conductive layer 118. However, having the third conductive layer 124 with a higher conductivity may further improve the grounding functionality of the conductive apparatus 100.

As the second conductive portion 104 fits to the underside of the footwear garment 200, providing a third conductive layer there may further enhance the durability and increase the service life of the conductive apparatus 100. Further, providing the third conductive layer only on the second conductive portion 104 that is more vulnerable to wear and tear may reduce the overall manufacturing cost of the conductive apparatus 100.

In some embodiments, as shown in FIG. 3, the third conductive layer 124 is attached to the second conductive layer 120 via a second conductive adhesive layer 126.

The second conductive adhesive layer 126 is a Xinst210 conductive adhesive tape.

In some embodiments, as shown in FIG. 3, the flexible strap may further include a vinyl layer 128. The vinyl layer 128 is provided on the connecting portion 106.

Preferably, the vinyl layer 128 includes: an adhesive-backed vinyl substrate 130; and a clear vinyl layer 132 covering the adhesive-backed vinyl substrate.

The vinyl substrate 130 has adhesive on at least both sides. The vinyl substrate 130 may have been printed with a predetermined pattern or design, e.g., with the brand or product name of the conductive apparatus 100. The clear vinyl layer 132 protects the pattern or design printed on the adhesive-backed vinyl substrate 130.

Prior to attachment to the footwear garment 200, the conductive device 100 further includes a protective layer 134 in the form of a liner covering the adhesive layer 112. The protective layer 134 stops the adhesive layer 112 adhering undesirably to other objects during storage or transport. The protective layer 134 is removed from the conductive device 100 prior to attachment to the footwear garment 200 by the user.

The conductive device 100 can be non-intrusive and lightweight for the user. The conductive device 100 may be easily and conveniently attached to an existing footwear garment, and easily removed after use.

As described hereinbefore, the conductive device 100 is elongated, having the first conductive portion 102 and the second conductive portion 104 at opposite ends of the conductive device 100.

Alternatively, in some other embodiments, the conductive device 100 may have any other suitable shape. For example, the conductive device 100 may have a loop shape, with the first conductive portion 102 formed on one side of the loop, and the second conductive portion 104 formed on an opposite side of the loop, with the connecting portion 106 including two portions extending from the first conductive portion 102 to the second conductive portion 104, thus forming a loop, and being able to extend along the outer portion 204 in two places, e.g., on both sides of the footwear garment 200.

Alternatively, in some other embodiments, the conductive device 100 may be elongated, with the first conductive portion 102 formed at or near the mid-point, and two second conductive portions 104 formed at two opposite ends respectively, and with two connecting portions 106 (e.g., to allow the conductive device 100 to extend out both sides to two grounding pads). Or vice versa, with the second conductive portion 104 formed at or near the mid-point, and the two first conductive portions 102 formed at two opposite ends respectively (e.g., to allow the conductive device 100 to extend in both sides to two inner pads).

Alternatively, in some other embodiments, the conductive device 100 may have a plurality of the first conductive portions 102 and/or a plurality of second conductive portions 104, connected by a plurality of the connecting portions 106.

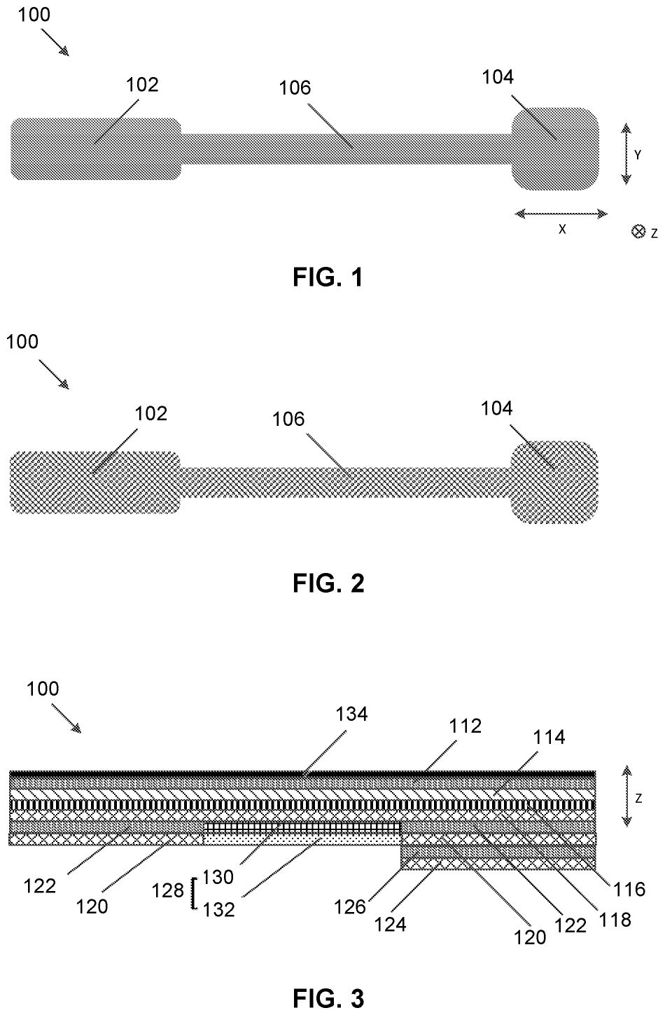

Further, as shown in FIGS. 1 and 2, in the present embodiment, the first conductive portion 102 and the second conductive portion 104 have a greater width than the connecting portion 106. Alternatively, in some embodiments, the conductive device 100 may have a unified width, i.e., substantially the same width for all three portions 102, 104 and 106.

Further, in the present embodiment, the first conductive portion 102 also has a greater length than the second conductive portion 104. Alternatively, the first conductive portion 102 may have a smaller length than the second conductive portion 104, or the same length as the second conductive portion 104.

Further, in the present embodiment, both the first conductive portion 102 and the second conductive portion 104 have substantially rectangular shapes. Alternatively, each of the first conductive portion 102 and the second conductive portion 104 may have any other suitable shape. The first conductive portion 102 and the second conductive portion 104 may have different shapes. The shape of the device 100 may allow for a practical understanding of how to fit the device 100 to the shoe.

As mentioned hereinbefore, in the present embodiment, both the first conductive portion 102 and the second conductive portion 104 are substantially flat or “planar”. As shown in FIG. 3, the first conductive portion 102 and the connecting portion 106 have substantially the same thickness, while the second conductive portion 104 is slightly thicker because of the second conductive adhesive layer 126 and the third conductive layer 124. The term “thickness” refers to the dimension in the vertical direction, shown by arrow Z, in

FIG. 3, which is orthogonal to the length and the width. Alternatively, in some other embodiments, the first conductive portion 102, the second conductive portion 104, and the connecting portion 106 may have substantially the same thickness. For example, in some embodiments, the conductive device 100 may not include the second conductive adhesive layer 126 and the third conductive layer 124. In some other embodiments, the first conductive portion 102 may have a smaller thickness than the second conductive portion 104 and the connecting portion 106, so that the footwear garment 200 with the first conductive portion 102 attached is more comfortable for a user to wear.

In the present embodiment, the conductive device 100 is adhesively attachable to the footwear garment 200. Alternatively, in some embodiments, at least one of the first conductive portion 102 and the second conductive portion 104 may be attachable to the footwear garment 200 by other means. For example, the footwear garment 200 may have loops, e.g., a fluffy inner and/or outer surface (e.g., the footwear may be a sock): accordingly, instead of an adhesive surface, one surface of the first conductive portion 102 and/or the second conductive portion 104 may have hooks that engage with the loops (e.g., like Velcro or hook-and-loop tape), so as to attach to the footwear garment 200 through a hook-and-loop engagement.

Further, in the present embodiment, the whole conductive device 100 is adhesively attachable to the footwear garment 200. Alternatively, in some embodiments, it may be that only the first and second conductive portions are adhesively attachable to the footwear, while the connecting portion 106 is not adhesive.

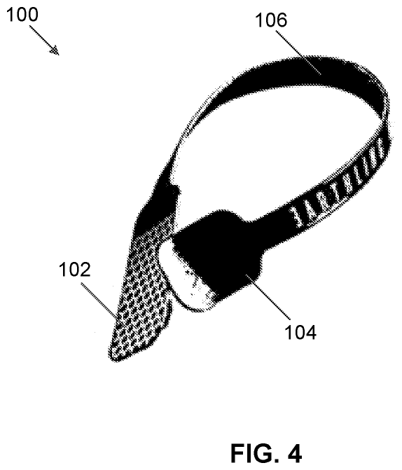

Further, as shown in FIG. 4, in the present embodiment, the whole conductive device 100 is made of flexible material. Alternatively, in some embodiments, at least one of the first and second conductive portions may be made of rigid material. For example, the second conductive portion 104 attachable to the outer portion 204 of the footwear garment 200 may be formed of rigid material.

Further, in the present embodiment, the conductive device 100 is made of a single unitary piece of a flexible strap. Alternatively, in some other embodiments, the first conductive portion 102 and the second conductive portion 104 may be two separate conductive patches, and the connecting portion 106 may be a flexible wire that electrically connects the two patches.

Further, in the present embodiment, the conductive apparatus 100 is provided in the form of a single conductive device 100. Alternatively, in some embodiments, the conductive apparatus may be provided in any other suitable form. For example, the conductive apparatus may be provided as an assembly or kit, including three separate components: two separate conductive patches and a flexible wire, which can be assembled by the user when using the apparatus.

Further, in some embodiments, in addition to the three conductive layers as described hereinbefore, the conductive apparatus 100 may include one or more further conductive layers, provided on at least the second conductive portion 104. For example, in one example the conductive apparatus 100 may include a fourth conductive layer attached to the third conductive layer 124 via a third conductive adhesive layer.

In some embodiments, the conductive apparatus 100 is provided in a kit 300, the kit 300 including: the conductive apparatus 100; a priming substance 310 for preparing an area on the underside of the footwear garment where the second conductive portion is to be attached; and at least one tool 320 for applying the priming substance to the area on the underside of the footwear garment.

The priming substance 310 may be a cleaning solvent (e.g., an alcohol-based primer) and/or an adhesion promoter (e.g., 3MTM Tape Primer 94).

The priming tool 320 may take the form of a swab, e.g., an alcohol and/or primer swab.

Providing the selected priming substance 310 and the priming tool 320 allows a user to clean the relevant areas on the footwear garment 200 before attaching the conductive apparatus 100 on those areas. This may also facilitate strengthening the bond between the conductive apparatus 100 and the footwear garment 200.

In at least one of the described embodiments, the conductive apparatus can be described as being in the form of a conductive adhesive strap for converting non-grounded shoes into grounded shoes. This conductive apparatus may provide the users, such as sports people, with similar health and recovery benefits as being barefoot, whilst allowing them to wear their regular footwear, such as rubber soled, outdoor training shoes.

According to at least some of the described embodiments, by providing a second conductive layer on the first conductive portion and the second conductive portion, the durability of the conductive apparatus 100 can be enhanced.

According to at least some of the described embodiments, by providing a third conductive layer on the second conductive portion, the durability of the conductive apparatus 100 can be further improved, and the service life of the conductive apparatus 100 can be increased.

In use, a user selects an area on the underside of the footwear garment 200, e.g., under the sole of a shoe, and removes excess dirt and/or debris from that area. If the user is using the kit 300, the user may apply the priming substance 310 to the selected area, e.g., by wiping the selected area with the priming substance 310 using the priming tool 320. The user then allows the selected area to dry for a predetermined period of time, e.g., 15 minutes.

Next, the user peels the protective layer 134 (liner) off from the conductive device 100, and positions the second conductive portion 104 on the underside 206 of the footwear garment 200, e.g., under the sole of a shoe. Preferably, the second conductive portion 104 is positioned close to or adjacent to the edge of the underside 206. The user applies a pushing force to the second conductive portion 104 for a suitable period of time, e.g., 2 minutes, so as to firmly attach the second conductive portion 104 to the underside 206 of the footwear garment 200.

The user positions the connecting portion 106 along at least portion of the outside of the footwear garment 200, e.g., the back or the side of the footwear garment 200, and applies a pressure to make the connecting portion 106 adapt to, and adhesively attach to, the contour the footwear garment 200.

The user feeds the first conductive portion 102 into the footwear garment 200, and firmly attaches the first conductive portion 102 to the inner portion 202 of the footwear garment 200, e.g., by pushing the remaining strap along the inner wall of the footwear garment 200.

After attaching the conductive device 100 to the footwear garment 200, the user may put the footwear garment 200 on and stand in it for a predetermined period of time, e.g., 30 seconds, to strengthen the bond between the conductive device 100 and the footwear garment 200.

The user may leave the conductive device 100 attached on the footwear garment 200 for a predetermined period of time before engaging in any intense activity in the footwear garment 200, e.g., 12 to 48 hours. This may ensure that the adhesive between the conductive device 100 and the footwear garment 200 dries sufficiently, and may prevent or reduce dirt or debris from getting between the conductive device 100 and the footwear garment 200.

After use, the user may manually peel the conductive device 100 off the footwear garment 200.

In some embodiments, the adhesive layer 112 may have a suitable strength to allow the conductive device 100 to be reused a number of times. Alternatively, the conductive device 100 may be replaced after being used once.

The conductive device 100 may be manufactured by the following steps: a. attaching (e.g., by laminating) the first conductive layer 118 (e.g., a conductive polymer film) to the transfer layer 116 (e.g., a transfer tape) to form a first sheet; b. attaching (e.g., by laminating) the flexible layer 114 (e.g., a flexible polymer film) to the adhesive layer 112 (e.g., an adhesive tape) to form a second sheet; c. attaching (e.g., by laminating) the transfer layer 116 of the first sheet to the flexible layer 114 of the second sheet; d. attaching (e.g., by laminating) a second conductive layer to the first conductive layer of the first sheet to form a flexible conductive sheet.

The lamination steps may be performed using known laminating equipment, e.g., flat bed rollers, or platen presses. This step may be completed with a regular laminator roller, or a screeding system.

In some embodiments, the manufacturing steps may further include: attaching the first conductive adhesive layer 122 to the first conductive layer 118; and attaching the second conductive layer 120 to the first conductive adhesive layer 122.

In some embodiments, the manufacturing steps may further include: attaching the adhesive-backed vinyl substrate 130 to the first conductive layer on the connecting portion; and attaching the clear vinyl layer 132 to the adhesive-backed vinyl substrate 130 to cover the adhesive-backed vinyl substrate 130.

In some embodiments, the manufacturing steps may further include: attaching the second conductive adhesive layer 126 to the second conductive layer 120; and attaching the third conductive layer 124 to the second conductive adhesive layer 126.

In any one of the above-described attaching steps, a primer may be used to prime the relevant surfaces before the attachment, e.g., by wiping a primer on the relevant surfaces. This may allow improving the bond between different materials during the attaching process, and may protect the different layers in the finished product from peeling apart. The primer may be a polymer-based adhesion promoter.

The formed flexible conductive sheet can be cut into a predetermined shape, e.g., the shape shown in FIGS. 1 and 2, to form the conductive apparatus 100 as described hereinbefore.

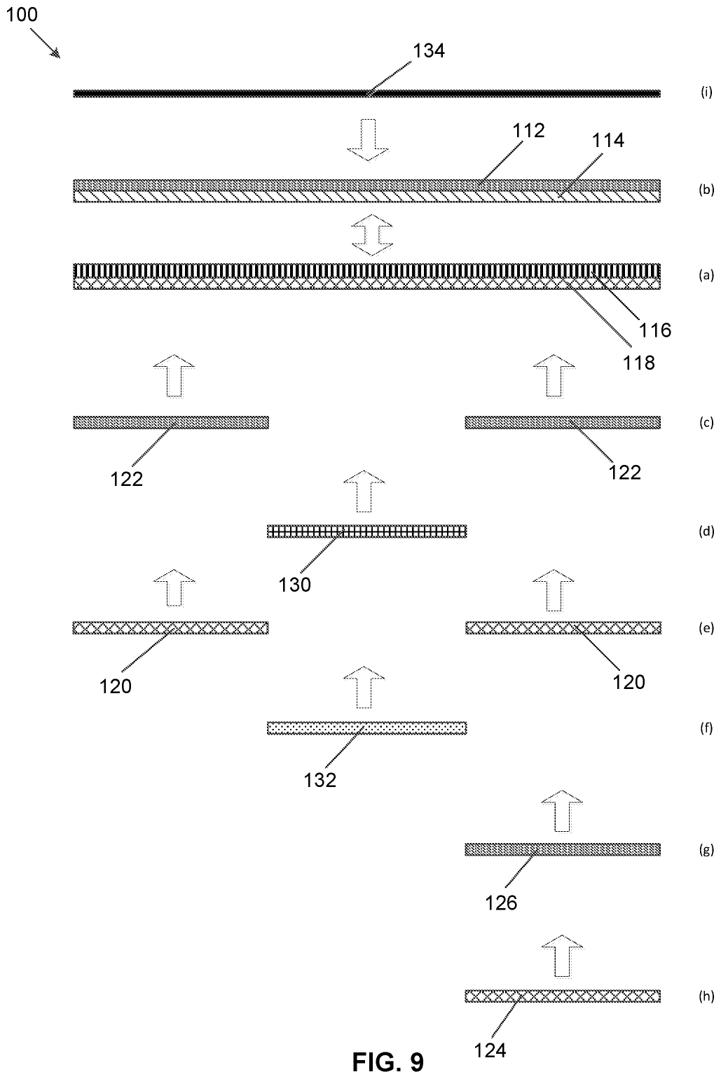

A more detailed example of the manufacturing process of the conductive apparatus 100 is illustrated in FIG. 9 and described as follows. In this example, the conductive apparatus 100 has all three conductive layers as shown in FIG. 3.

First, materials of the above-described layers are prepared. The materials may be supplied in, for example, slit rolls (e.g., 300 mm in width) or uncut log rolls (e.g., more than 1 meter in width).

The flexible layer 114 and the adhesive layer 112 are then laminated together to form the second sheet, as shown in FIG. 9(a).

The flexible layer 114 may be primed on one side to be attached to the adhesive layer 112, e.g., by using a primer. The priming process may involve setting up both nitrile rubber and double-sided adhesive rolls on a laminator, and wiping Primer 94 on an inner surface of the nitrile rubber as the laminator slowly presses the materials together. The term “inner” here refers to the surface of the material that is to be attached to a corresponding surface of another material during lamination. The laminating speed of the laminator may be set to allow the primer to dry for a predetermined time period (e.g., about 15 seconds) before pressing the materials together.

A similar laminating process may be used to laminate the first conductive layer 118 to the transfer layer 116 to form the first sheet, as shown in FIG. 9(b). The carbon loaded conductive polyethylene film may be primed on its inner surface prior to lamination, e.g., by using Primer 94.

The same lamination/priming process is then used to attach the first sheet to the second sheet. The inner surface of the flexible layer 114 (nitrile rubber) may be primed, e.g., by using Primer 94, so that it can bond more securely with the transfer layer 116.

Once the first sheet and the second sheet have been laminated, they may be cut into smaller sheets (e.g., 300 mm×300 mm).

The sheets may then be set up on a vacuum table to keep them completely flat. The top of each sheet may then be primed, e.g., by wiping Primer 94 on the sheets.

Once primed, a jig is then positioned on a sheet to accurately identify the position on the sheet where further materials will be attached.

Next, as shown by FIG. 9(c), the first conductive adhesive layer 122 is laminated to the first conductive portion 102 and the second conductive portion 104 (shown as the left and right ends of the sheet in FIG. 9, respectively), leaving the connecting portion 106 (the middle section in FIG. 9) exposed.

Once the first conductive adhesive layer 122 is laminated, the same process is followed, but this time the adhesive-backed vinyl substrate 130 is laminated to the connecting portion 106 (the middle, exposed section of the sheet as shown in FIG. 9), as shown by FIG. 9(d). This vinyl substrate 130 may have been printed with a predetermined pattern or design, e.g., with the brand name of the conductive apparatus 100.

As shown in FIG. 3, the first conductive adhesive layer 122 on both ends of the sheet and the adhesive-backed vinyl substrate 130 in the middle section abut each other to form a continuous surface.

The same lamination process is followed again to laminate the second conductive layer 120 (e.g., a polyethylene with a higher conductivity) to the first conductive adhesive layer 122 on the first conductive portion 102 and the second conductive portion 104 (i.e., the left and right ends of the sheet in FIG. 9) of the sheet, as shown in FIG. 9(e).

The connecting portion 106 (i.e., middle section of the sheet in FIG. 9) is then laminated with the clear vinyl 132 to cover the adhesive-backed vinyl substrate 130. This allows the pattern or design printed on the adhesive-backed vinyl substrate 130 to be protected in the finished product.

The same process of laminating the first conductive adhesive layer 122 and the second conductive layer 120 is followed again, to laminate the second conductive adhesive layer 126 and the third conductive layer 124 to the sheet, as shown by FIG. 9(g) and FIG. 9(h), respectively. The second conductive adhesive layer 126 and the third conductive layer 124 covers only the second conductive portion 104 (right hand side of the sheet as shown in FIG. 9), which is the side that fits under the footwear garment. Adding this extra conductive layer increases the durability of the conductive apparatus 100.

In addition, as shown by FIG. 9(i), the protective layer 134 in the form of a liner may be attached to the sheet to cover and protect the adhesive layer 112.

The sheet may then be cut into a predetermined shape, e.g., the shape shown in FIGS. 1 and 2, to form the conductive apparatus 100 as described hereinbefore. The cutting may be conducted using a die form.

Once the cutting is completed, the conductive apparatus 100 may then be packaged together with the priming substance 310 and the priming tool 320 for preparing the footwear garment 200, thereby forming the kit 300.

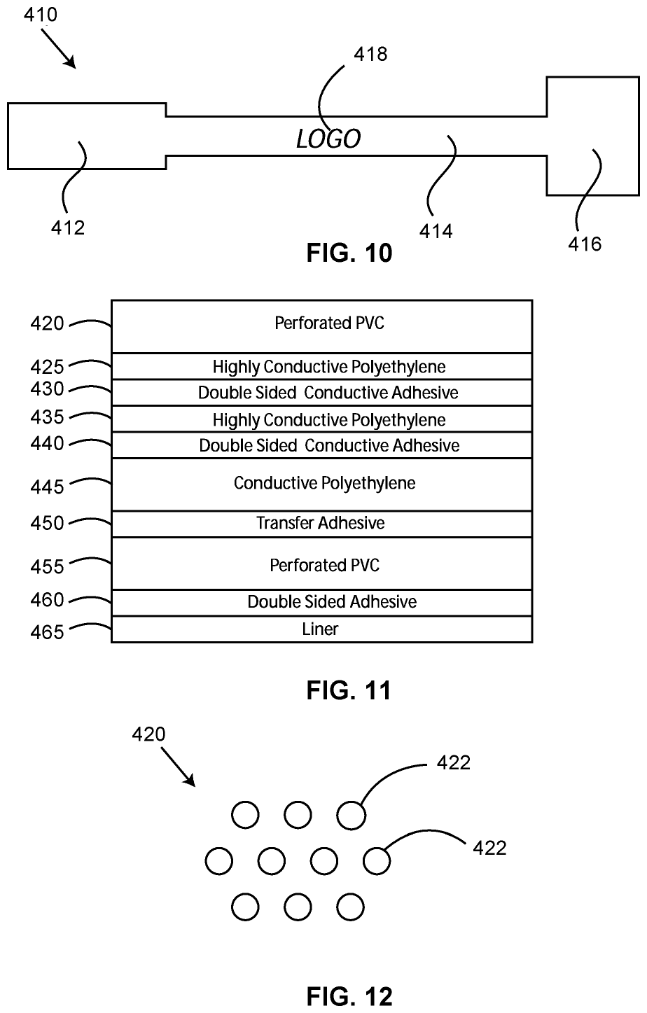

Referring now to FIGS. 10-14, an embodiment of the present invention also provides a personal earthing strap comprising multiple layers with different characteristics to give the strap durability and high conductivity. The uppermost conductive layer sits under a perforated top layer which can be printed on and allows contact with the conductive layer.

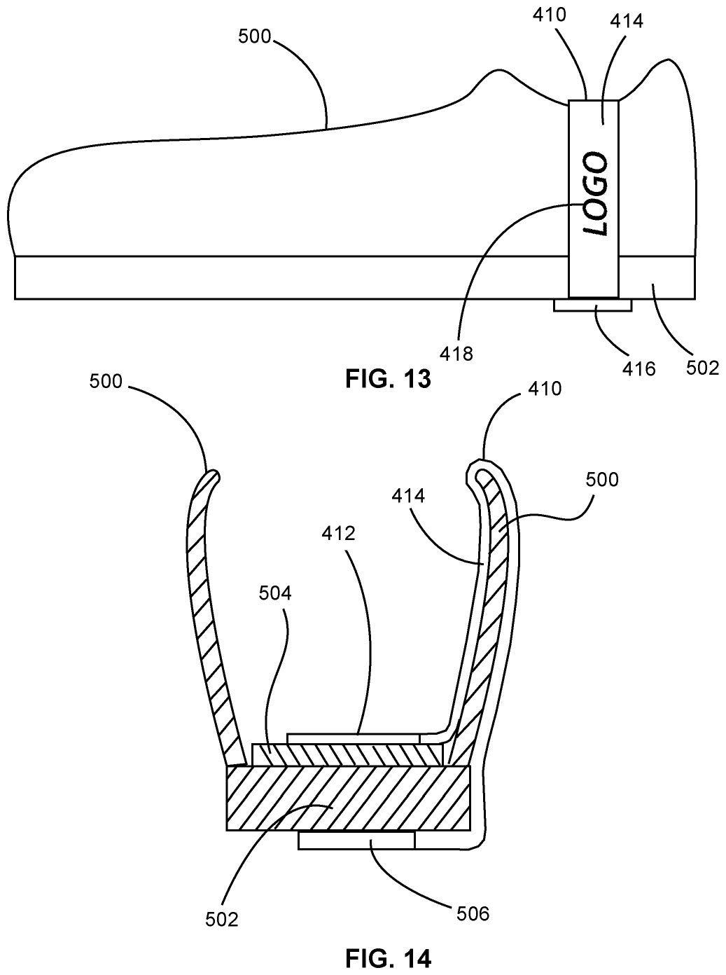

An earthing strap 410 is shown from above in FIG. 10. The strap 410 is approximately 150 mm long and 4 mm thick and comprises a shoe end section 412 which in use is positioned on the top of the inner sole of a shoe, a ground end section 414 normally which in use is positioned under the sole of a shoe, and a joining section 416 which joins the shoe end section to the ground end section. The strap is attached to the shoe via double sided adhesive and is generally conductive to allow static to be discharged from a foot in contact with the foot end section to earth via the ground end section. The top layer of the strap can be printed on to include a logo 418. The strap is shown fitted to a shoe 500 in FIG. 13 and FIG. 14 which are discussed further below.

The strap 410 comprises a series of layers which can be appreciated with the cross sectional view of FIG. 11. The vertical scale of FIG. 11 is greatly exaggerated to allow the composition of the strap to be appreciated, likewise the relative height of some layers are exaggerated. Whilst all layers aid in providing a mechanically robust strap they fall roughly into three categories: a top layer to support printing; multiple conductive layers; and a series of layers to provide mechanical strength and adhesion.

The various layers may be formed from a variety of materials with appropriate properties. Polyvinyl chloride (PVC) is preferably used for most layers to provide strength and flexibility. The conductive layers are preferably polyethylene impregnated with carbon.

The perforated top layer 420 is formed from 0.2 mm thick PVC with a series of 1.5 mm perforations 422 separated from each other by 1.5 mm as shown in FIG. 12. This arrangement of perforations maintains strength whilst allowing contact with the first conductive layer 425 below. The top layer can be printed on, with the ink adhering to the spaces between the perforations. At a distance the perforations are un-noticeable, allowing for the clear display of a logo 418 or the like. The top layer is coated underneath with a non-conductive adhesive.

Beneath the perforated top layer 420 sits first and second highly conductive layers 425, 435 held together with a double sided conductive adhesive 430. The conductive layers 425, 435 are formed from a polyethylene file approximately 0.1 mm thick and impregnated with carbon to give a surface resistivity of approximately 200 Ω/sq. Before assembly the conductive layers are primed to promote adhesion with an acetone primer. A further layer of double-sided conductive adhesive 440 sits between the second conductive 435 layer and an energy absorbing layer 445 which is also a lightly conductive layer. The energy absorbing layer is a polyethylene file approximately 0.2 mm thick and lightly impregnated with carbon to give a surface resistivity of approximately 200 kΩ/sq. This adds to the overall conductivity to the strap whilst still remaining flexible. The relatively low carbon content of the energy absorbing layer in comparison to the first and second conductive layers, allows it to stay suitably flexible for absorbing loads. The energy absorbing layer is also primed before assembly.

Beneath the conductive layers sits a transfer adhesive layer 450 which attaches a lateral strength layer 455 comprising approximately 0.3 mm thick perforated PVC to give lateral strength to the strap. The strength layer is semi-rigid PVC to add some structure to the strap.

Finally beneath the lateral strength layer sits a layer of double sided adhesive 460 to attach the strap to a shoe. Before use the adhesive layer is protected by an adhesive liner 465 which is easily peeled off when desired.

The combination of the various layers used has been found to provide both higher conductivity and superior durability to the strap when compared to a strap that comprises a single conductive layer and a single strength layer. The perforated also adds to the durability whilst allowing the strap to be printed upon.

FIG. 13 shows a side view of a shoe 500 with a strap 410 fitted, with FIG. 14 showing a cross sectional view. To fit the strap 410 to the shoe, the adhesive protector layer 465 is first removed and then strap pressed against the shoe as shown with the double sided adhesive layer 460 in contact with the shoe. The shoe end section 412 is positioned on the top of the inner sole 504 of the shoe; the joining section 416 is run across the inner sole 504, up the inside of and down the outside of the side 506 of the shoe, and across the sole 502 of the shoe. The ground end section 414 is positioned under the sole of the shoe. The shoe end section is typically positioned first as its location will affect the comfort of the user. Once the strap is in position the logo 418 is prominently facing outward from the side of the shoe.

The reader will now appreciate this embodiment which provides an effective personal earth strap that is both durable and printable.

### DRAWING COMPONENTS

The drawings include the following integers:

100 conductive device

102 first conductive portion

104 second conductive portion

106 connecting portion

112 adhesive layer

114 flexible layer

116 transfer layer

118 first conductive layer

120 second conductive layer

122 first conductive adhesive layer

124 third conductive layer

126 second conductive adhesive

128 vinyl layer

130 vinyl substrate

132 clear vinyl layer

134 protective layer

200 footwear garment

202 inner portion

204 outer portion

206 underside

208 outside

310 kit

310 priming substance

320 priming tool

400 earthing strap

412 shoe end section

414 joining section

416 ground end section

418 printed logo

420 perforated top layer

422 perforations

425 first conductive layer

430 double sided conductive adhesive

435 second conductive layer

440 double sided conductive adhesive

445 energy absorbing layer

450 transfer adhesive

455 lateral strength layer

460 double sided adhesive

465 adhesive liner

500 shoe

502 sole

504 inner sole

506 side wall

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Many modifications will be apparent to those skilled in the art without departing from the scope of the present invention.

1. A conductive apparatus, including: a first conductive portion for attaching to an inner portion of a footwear garment; a second conductive portion for attaching to an underside of the footwear garment; and a connecting portion that at least partly extends along an outside of the footwear garment, the connecting portion electrically connecting the first conductive portion and the second conductive portion; wherein the conductive apparatus is a flexible strap including: an adhesive layer; a first conductive layer; and a second conductive layer provided on at least the second conductive portion.

2. The conductive apparatus of claim 1, wherein the flexible strap further includes a flexible layer located between the adhesive layer and the first conductive layer.

3. The conductive apparatus of claim 2, wherein the flexible strap further includes a transfer layer located between the flexible layer and the first conductive layer.

4. The conductive apparatus of claim 1, wherein the flexible strap further includes a first conductive adhesive layer for attaching the second conductive layer to the first conductive layer.

5. The conductive apparatus of claim 1, wherein the second conductive layer is provided on the first conductive portion and the second conductive portion.

6. The conductive apparatus of claim 1, wherein the second conductive layer has a higher conductivity than the first conductive layer.

7. The conductive apparatus of claim 1, wherein the flexible strap further includes a third conductive layer.

8. The conductive apparatus of claim 7, wherein the flexible strap further includes a second conductive adhesive layer for attaching the third conductive layer to the second conductive layer.

9. The conductive apparatus of claim 7, wherein the third conductive layer is provided at least on the second conductive portion.

10. The conductive apparatus of claim 7, wherein the third conductive layer has a higher conductivity than the first conductive layer.

11. The conductive apparatus of claim 1, wherein the flexible strap further includes a vinyl layer provided on the connecting portion.

12. The conductive apparatus of claim 11, wherein the vinyl layer includes: an adhesive-backed vinyl substrate; and a clear vinyl layer covering the adhesive-backed vinyl substrate.

13. (canceled)

14. (canceled)

15. (canceled)

16. (canceled)

17. (canceled)

18. (canceled)

19. (canceled)

20. (canceled)

21. A kit for applying a conductive apparatus to a footwear garment, including: a conductive apparatus, including: a first conductive portion for attaching to an inner portion of the footwear garment; a second conductive portion for attaching to an underside of the footwear garment; and a connecting portion that at least partly extends along an outside of the footwear garment, the connecting portion electrically connecting the first conductive portion and the second conductive portion; a priming substance for preparing an area on the underside of the footwear garment where the second conductive portion is to be attached; and at least one priming tool for applying the priming substance to the area on the underside of the footwear garment.

22. The kit of claim 21, wherein the priming tool is a swab.

23. (canceled)

24. A personal earthing strap comprising at least one conductive layer and a top layer, wherein the top layer is formed from a material that accepts printing, and wherein the top layer is perforated to allow contact with a conductive layer beneath the top layer.

25. The personal earthing strap as in claim 24, wherein the strap comprises a plurality of conductive layers held together with double sided conductive adhesive.

26. The personal earthing strap as in claim 24, wherein a first conductive layer comprises a relatively high proportion of carbon to provide a relatively low surface conductivity, and a second conductive layer comprises a relatively low proportion of carbon to provide a relatively high surface conductivity.
